(19) United States
(12) Patent Application Publication
(10) Pub. No.: US 2026/0340638 A1
(43) Pub. Date: Oct. 29, 2026

(54) SYSTEM FOR WEIGHTING LINKS BETWEEN ACCOUNTS AND MERCHANT NODES IN A NETWORK GRAPH OF TRANSACTIONS

(71) Applicant: The PNC Financial Services Group, Inc., Pittsburgh, PA (US)

(72) Inventors: Sarah Parody, Colonial Beach, VA (US); Andrew Patrick Lynch, Gibsonia, PA (US)

(21) Appl. No.: 19/188,696

(22) Filed: Apr. 24, 2025

(51) Int. Cl. G06Q 20/40

(52) U.S. Cl. CPC G06Q 20/4016

(57) ABSTRACT

Systems and methods of the present invention receive transaction data for a plurality of network nodes. The systems and methods may generate a network graph for the plurality of nodes based on the transaction data, wherein the plurality of nodes comprises merchant nodes and customer account nodes, and wherein the network graph connects the merchant nodes and the customer account nodes through a plurality of edges. The systems and methods may assign a fraud metric value to the plurality of nodes based on a fraud metric algorithm and the network graph. The systems and methods may determine the fraud metric value for one or more of the plurality of nodes exceeds a fraud threshold, wherein the fraud threshold is based on a fraud detection model. The systems and methods may automatically deploy or transmit a fraud response associated with the one or more of the plurality of nodes based on the determination that the one or more of the plurality of nodes exceeds the fraud threshold.

### BACKGROUND

The prevalence and sophistication of eCommerce has reduced the barriers to entry for new merchants (e.g., retailers) allowing them to start online businesses overnight. For some merchants, 100% of their sale may be through online transaction without a brick-and-mortar location. Many financial institutions have recognized that these business practices, although well accepted, subject customers to situations that did not exist for in-person transactions. For example, a customer makes a purchase online but the item they receive is different, not as expected, or they did not receive it at all. To instill confidence, financial institutions have provided another layer of protection for customers to reimburse them for these situations.

However, fraudulent actors have recognized these protections offered by financial institutions and have exploited them by manipulating transactions with fake merchants and customer accounts. However, it can be difficult to differentiate legitimate activity by a small online merchant from fraudulent activity by fake merchants.

Network graphs, in graph theory, can be useful to provide helpful insight regarding the interaction between merchant nodes and customer account nodes in these networks. For example, they may help to identify importance of merchants and potential for fraud in a network. Additionally, financial institutions have access to massive datasets that can be used to generate these network graphs that link merchants and customer accounts based on various parameters in transaction data. Once a network graph is generated, various graphing algorithms are used to generate metrics for each node and indicate the various analytics about the merchants and customer accounts.

Traditional graphing algorithms calculate various metrics for each node including centrality (e.g., degree, closeness, betweenness, eigenvector). These graphing algorithms can show the impact, popularity, and growth of merchant nodes, and typical customer activity in the network based on the number and frequency of transactions, and the average and total amounts spent over a predetermined period. However, these traditional graphing algorithms overemphasize the activity of large merchants and provides little insight for identifying fraudulent merchants and fraudulent activity. Furthermore, the size and volume associated with massive retailers creates noise that obfuscates analytics that would otherwise be helpful in identifying fraudulent activity in the payment networks.

### SUMMARY OF THE INVENTION

In one general aspect, the present invention is directed to computer-implemented systems and methods for detecting fraudulent activity in electronic financial transactions using a dynamically weighted network graph of nodes. In various embodiments, the system receives transaction data corresponding to customer accounts and merchant accounts, and generates a network graph that connects these nodes through a plurality of edges. Each edge may represent one or more transactions, and may be weighted based on transaction frequency, monetary value, or other behavioral attributes.

The system calculates a fraud metric value for each node using a fraud metric algorithm. This algorithm may incorporate graph-based metrics such as inverse degree centrality, node similarity, and community affiliation to distinguish between typical transaction behavior and patterns indicative of fraud. Unlike traditional metrics that emphasize popular or highly connected nodes, the inverse centrality component reduces the influence of large retailers and highlights outlier nodes that may correspond to fraudulent actors.

A fraud detection model trained on historical transaction data assigns dynamic thresholds corresponding to various fraud types. When a node's fraud metric value exceeds the applicable threshold, the system automatically deploys a fraud response. Fraud responses may include flagging or freezing the account, blacklisting related identifiers, requesting tax documentation, lowering credit limits, or generating structured alerts to regulatory authorities.

In certain embodiments, the system also processes real-time transaction data. It evaluates the current transaction in the context of the network graph and the fraud metric values of the involved nodes. Based on this evaluation and the fraud detection model, the system may deny authorization, issue alerts, or take preventative actions.

Embodiments of the present invention can provide the ability to identify sophisticated and low-signal fraudulent activity—such as fraud rings, synthetic identity fraud, and transaction laundering—by leveraging advanced graph analytics and dynamic risk modeling. The invention can enable financial institutions to move beyond reactive fraud detection and implement scalable, real-time decision systems that improve fraud mitigation, reduce false positives, and enhance regulatory compliance. These and other benefits that can be potentially realized through embodiments of the present invention will be apparent from the description that follows.

### BRIEF DESCRIPTION OF THE DRAWINGS

Various embodiments of the present invention are described herein by way of example in connection with the following figures.

FIG. 1 shows a block diagram for a payment network, according to various aspects of the present invention.

FIG. 2 shows a block diagram for a network comprising a fraud detection server, according to various aspects of the present invention.

FIG. 3 shows a network graph generated based on historical data between a plurality of network nodes, according to various aspects of the present invention.

FIG. 4 shows a logic flow diagram for detecting fraudulent activity based on a network graph for a plurality of nodes, according to various aspects of the present invention.

FIG. 5 shows a logic flow diagram for detecting fraudulent activity based on a network graph for a plurality of nodes, according to various aspects of the present invention.

### DETAILED DESCRIPTION

The present invention describes methods and systems for detecting rare, atypical, and/or unusual but heavily-interconnected fraudulent activity (e.g., fraud rings, self-dealing, etc.) with a network graph. The network graph comprises a plurality of network nodes, with, for example, some or all of the nodes corresponding to customer or merchant accounts, and where the nodes are connected by a plurality of edges. The system may employ weighted graphing algorithms to analyze and de-emphasize the impact created by large merchants, such as Amazon and Walmart, in the network graph.

In various aspects, one or more network graphs may be generated based on different parameters of transaction data between merchants and customer accounts. The network graphs may be evaluated based on one or more weighted graphing algorithms configured to model fraudulent activity between merchant nodes and customer nodes. The systems may employ different weighting algorithms to identify different fraudulent activities and may automatically provide network responses based on the fraud type and a threshold value associated with the network nodes.

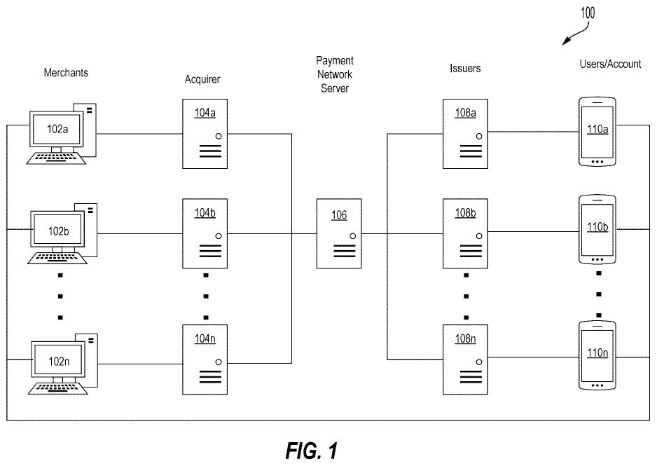

FIG. 1 shows a block diagram for a payment network 100, according to various aspects of the present invention. The payment network 100 comprises a plurality of merchants 102a-n, a plurality of users 110a-n associated with customer accounts, acquirer systems 104a-n (e.g., financial institution computing resources associated with processing and receiving payment for merchants), issuer systems (e.g., financial institution computing resources associated with processing and providing payment for customers), and a payment network service provider server 106 (e.g., financial network configured to facilitate financial transactions between the merchants and the customers). The acquirer systems 104a-n, the payment network service provider 106, and the issuer systems 108a-n comprise a plurality computing resources including at least processing servers in communication through the payment network. A financial institution may play multiple roles within the payment network 100 where it may act as an acquirer system 104 that processing payment transactions for merchants 102 and an issuer system 108 that processes purchase transactions for customers 110. The financial institution may collect and store transaction data, generated by various nodes (e.g., customers and merchants) within the payment network, which can be used to generate network graphs.

The payment network 100 is preferably implemented as a distributed computing architecture comprising a plurality of interconnected systems that facilitate the authorization, processing, and settlement of electronic financial transactions between merchant entities and customer accounts. The network includes merchant systems 102a-n, acquirer systems 104a-n, issuer systems 108a-n, centralized or federated payment network server 106, and user accounts 110a-n, each of which is associated with a customer initiating transactions within the system.

When a customer initiates a transaction with a merchant—typically via a point-of-sale terminal, eCommerce interface, or mobile application associated with merchant system 102—the merchant transmits an authorization request to its affiliated acquirer system 104. The acquirer system 104 operates on behalf of the merchant to interface with the broader payment network, and is implemented as a set of financial institution computing resources configured to process merchant-originated transaction data. The acquirer system encapsulates the transaction data, including the account credentials (e.g., payment card number, tokenized identifier, transaction amount, timestamp, and merchant ID), and forwards the request through the payment network 106.

The payment network 106 can serve as a routing and authorization backbone, operating as an intermediary between the acquirer system and the appropriate issuer system 108 associated with the customer account. The payment network server receives the authorization request and performs various routing, validation, and logging operations. It can determine the destination issuer system based on the account information, performs risk assessment logic (including potentially invoking fraud detection mechanisms), and forwards the transaction payload to the identified issuer system 108.

The issuer system 108 can comprise computing infrastructure controlled by the customer's financial institution. Upon receiving the authorization request, the issuer system evaluates the request based on the customer's account status, available balance or credit, fraud risk indicators, and recent transaction history. If the transaction is deemed valid, the issuer system generates an approval response, which is routed back through the payment network 106 to the originating acquirer system 104 and then on to the merchant system 102, completing the authorization phase of the transaction. If the transaction is flagged as suspicious or unauthorized, the issuer system may decline the request, and optionally trigger internal fraud response protocols such as account flagging or real-time risk scoring.

The customer account 110, associated with the user initiating the transaction, is typically hosted within the issuer system 108. It is modeled as a set of structured records representing account balances, user identifiers, and transaction history. The issuer system may also maintain session data and authorization tokens for authenticating ongoing interactions with the payment network. Throughout the transaction lifecycle, the payment network 106 maintains session state and logging to ensure accountability and traceability for regulatory and operational purposes.

Communication between all components preferably is secured using transport-layer encryption protocols (e.g., TLS), and messages are formatted in industry-standard protocols such as ISO 8583 or ISO 20022. The systems may use message queuing, RESTful APIs, or proprietary interbank messaging protocols to ensure reliable delivery and processing of transactional data. In certain implementations, components such as the payment network server 106 and issuer systems 108 may leverage redundant, distributed cloud-based infrastructure to achieve scalability and high availability.

In various aspects, the network graphs may be generated based on hundreds of millions of data points from historical data including transaction data between merchants and customer accounts. For example, a fraud detection service (e.g., service within a financial institution, payment network service provider, or third-party service) may catalog historical transaction data from customer and merchant accounts that may be used to generate network graphs. In another example, a financial institution may collect and store the transaction data in a database through ordinary its course of business, in order to comply with governmental regulations such as the Bank Secrecy Act (BSA) and the Anti-money Laundering Act (AMLA). This data may be used to create one or more network graphs that can be analyzed based on different graphing algorithms to identify fraudulent activity between customer accounts and merchants. This allows the financial institution the ability to leverage existing data to mitigate and prevent fraudulent actors from manipulating safe guides that were put in place to protect customers.

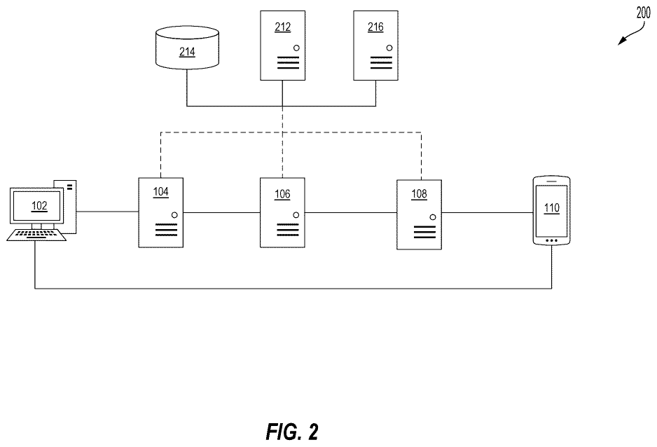

FIG. 2 shows a block diagram for a fraud detection network 200 comprising a fraud detection server 212, according to various aspects of the present invention. The network 200 may facilitate the collection and transmission of transaction data between an acquirer system 104 or an issuer system 108 to the fraud detection server 212. The issuer system 108 may receive transaction data as part of an authorization request by a customer account 110. Once the issuer system 108 approves the authorization request, the transaction data may be stored in a transaction database 214. The transaction database 214 may be part of the fraud detection server or an external service in communication with the fraud detection server 212. The fraud detection server 212 may generate a network graph based on historical data from the transaction database 214 and may be updated at predetermined time intervals (e.g., every business day). For example, the network graph may be updated based on daily batch updates or real-time updates to the transaction database 214 from newly compiled transaction data. The fraud detection server may receive real-time transaction data to determine whether and which type of fraud response is necessary based on the real-time transaction data. The fraud response may be determined based on the real-time transaction data, a fraud metric value, node similarity, and/or community affiliation for the merchant node and the customer node associated with the transaction.

The transaction data may be requested, retrieved, and/or pushed/pulled by/to the fraud detection server 212 from the transaction database 214, the issuer system 108, the acquirer system 104, and/or an external resource 216. In various aspects, the transaction database 214 and the fraud detection server 212 may be internal or external to the financial institutions' network, local computing resources, or distributed cloud resources. For example, the fraud detection server 212 may receive a daily transaction file to update the network graph based on the transactions that occurred in the previous day. Additionally, the fraud detection server 212 may receive fraud detection data or a fraud detection model based on daily updates. The fraud detection data and/or fraud detection model may identify patterns or merchant nodes that associated with fraudulent activity allowing the model to assign weightings and fraud thresholds to account for fraudulent actors in the network graph. The fraud detection server 212 may be configured to train the fraud detection model based on historical fraud detection data, or alternatively, to receive a pretrained model generated by an internal machine learning pipeline or an external third-party provider.

In various embodiments, the transaction database 214 may be implemented using a structured and scalable data storage architecture configured to store transaction records generated throughout the payment network. The transaction database 214 may be embodied as a relational database, a non-relational database, a distributed key-value store, or a combination thereof, depending on the volume of transaction data, latency requirements, and the computational architecture of the fraud detection server 212.

In one embodiment, the transaction database 214 is implemented as a relational database management system (RDBMS), such as PostgreSQL, MySQL, Microsoft SQL Server, or Oracle Database. The database may comprise one or more normalized tables configured to store structured transaction data. Each record may correspond to a transaction and may include fields such as: a unique transaction identifier, timestamp, customer account identifier, merchant identifier, transaction amount, transaction type, currency code, authorization response code, and merchant category code (MCC). Foreign key relationships may be used to associate transaction records with corresponding customer or merchant profile tables, thereby supporting complex queries involving historical transaction behavior across specific entities or groups.

In another embodiment, the transaction database 214 may be implemented using a distributed, horizontally scalable data store such as Apache Cassandra, Amazon DynamoDB, or Google Cloud Bigtable. These distributed databases may be configured to support high-ingestion workloads and may store transaction records as wide rows or key-value pairs. In such implementations, the transaction data may be partitioned across multiple nodes based on a partition key such as account ID, merchant ID, or a combination of account ID and transaction timestamp. The distributed nature of the database enables low-latency access to transaction data and ensures high availability and fault tolerance, which may be important for real-time fraud detection.

The transaction database 214 may be further configured to support data streaming, real-time updates, or batch ingestion. In certain aspects, the database 214 may receive transaction data in real time from one or more issuer systems 108 or acquirer systems 104, using secure APIs or message queues (e.g., via Apache Kafka, Amazon Kinesis, or another event-driven architecture). In other implementations, the database may receive daily or periodic batch files from upstream systems to reflect new transaction activity. These updates may be scheduled at fixed intervals (e.g., hourly, daily) or triggered dynamically based on transaction volume or risk thresholds.

The transaction database 214 may also support secondary indexing, allowing efficient retrieval of transaction records based on various attributes, including account ID, merchant ID, transaction amount range, transaction date, or MCC. In some embodiments, the transaction database 214 may include data partitioning and archival strategies to manage long-term storage. For example, historical transaction data beyond a specified retention period may be moved to a cold storage tier or exported to a data lake or columnar storage format (e.g., Apache Parquet or ORC) for offline analytics or regulatory audits.

For purposes of security and compliance with data protection regulations (e.g., PCI-DSS), the transaction database 214 may support encryption at rest and in transit, as well as tokenization or masking of sensitive account data. Access to the database may be controlled using role-based access control (RBAC), audit logging, and authentication protocols integrated with the broader financial institution's infrastructure.

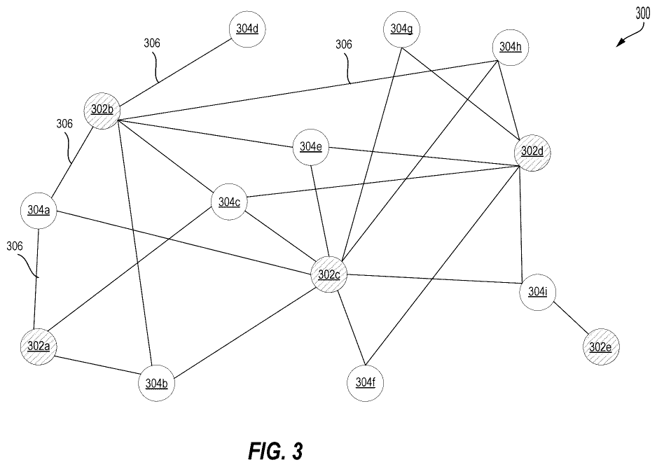

FIG. 3 shows a network graph 300 generated based on historical data between a plurality of network nodes, according to various aspects of the present invention. The network graph 300 comprises a plurality of network nodes representing merchant accounts as merchant nodes 302a-e and customer accounts as customer account nodes 304a-i connected by a plurality of edges 306. The edges 306 may comprise weighted values that represent various transaction parameters between a merchant and a customer account such as number of transactions, the number of transactions in a predetermined period, the transaction amount, the average transaction amount in a predetermined period, and/or the overall transaction amount in a predetermined period. The weighted edge values may be normalized based on the number of transactions or purchase amounts (e.g., maximum, average, median) made by customer account node for a given merchant node in a predetermined period. For example, customer account nodes 304a-c show all edges for a merchant node 302a. The customer account node 304c may have 4 transactions in a predetermined period, while customer account nodes 304a and 304b may have 2 transactions each in the same period. The weighted edge value between customer account node 304c and merchant node 302a may be represented as a normalized value of 0.5, and the edges between 304a and 304b may be 0.25.

The network graphs described may be embodied electronically using a variety of structured data formats and data structures, depending on the system architecture, volume of data, and performance requirements. At a foundational level, the graph can be represented as a set of nodes and edges, where nodes correspond to merchant accounts and customer accounts, and edges represent transactional relationships between them, potentially with associated weights based on transaction characteristics.

In one embodiment, the graph may be stored as a set of relational database tables. For example, one table may store node information, with each row representing a node and associated metadata such as node type (merchant or customer), account ID, and account attributes. A separate table may store edge data, where each row defines a source node, a target node, and one or more weighted values (e.g., transaction count, total spend, average purchase amount over a time window). These tables can be queried and joined to construct the graph structure in memory for analysis using graph algorithms.

Alternatively, the network graph may be stored in a non-relational format using a graph database such as Neo4j, Amazon Neptune, or TigerGraph. These platforms natively support nodes, edges, and property graphs, allowing for efficient storage and traversal of complex relationships. Each merchant or customer node can be stored as a vertex, and edges can store properties such as timestamps, transaction frequency, and weighted metrics. Graph query languages like Cypher or Gremlin may be used to extract subgraphs, compute centrality measures, or perform community detection.

In more lightweight or exportable scenarios, the graph can be embodied in structured file formats such as Comma-Separated Values (CSV) or JavaScript Object Notation (JSON). A CSV file may contain a node list (e.g., node_id, node_type, attributes . . . ) and a separate edge list (e.g., source_node_id, target_node_id, weight). JSON-based formats may represent the graph as a nested object, where each node includes a list of connected nodes and edge attributes. These formats are commonly used for importing and exporting graph data between systems or feeding external analytics pipelines.

For large-scale processing, especially in distributed environments, the network graph may be implemented using in-memory graph processing frameworks such as Apache Spark GraphX or Apache Flink's Gelly API. In these cases, the graph data is partitioned and stored in distributed memory as RDDs or data streams, allowing parallel computation of fraud metrics and near-real-time updates to graph structures based on new transaction data.

In practice, a combination of storage approaches may be used. For instance, historical graphs may be archived in compressed CSV or Parquet files for long-term storage and batch processing, while recent graph snapshots may reside in a high-performance graph database for real-time querying. Such storage formats may be versioned and signed with cryptographic checksums (e.g., SHA-256 hashes) to ensure integrity and traceability of graph data over time. Edge attributes such as transaction count, volume, and recency can be updated continuously as new transaction data streams into the system, supporting dynamic fraud detection workflows.

Once the network graph is generated for a plurality of transactions between a plurality of merchants and a plurality of customer accounts, the fraud detection server 212 may calculate metric values for each network node based on a fraud metric algorithm. The fraud metric algorithm may determine metric values for each node based on weighted edge value, node centrality, account node similarity, and/or community affiliation.

In traditional network graphs, node centrality is calculated as a metric that measures the network influence, node importance, or market share for each node in a network. For example, node centrality may be calculated as degree centrality, closeness centrality, betweenness centrality, or eigenvector centrality. The degree centrality metric measures a node's popularity within the network based on the number of edges for each node. Each edge may correspond to one or more transactions or transaction amounts between a customer account and a merchant. The closeness centrality metric measures the average “distance” from a node to all other nodes in the network and may indicate the popularity of a node in comparison to the size of the network. Nodes that have an attenuated relationship to all other nodes may correlate to fake or fraudulent account nodes. The betweenness centrality metric measures the frequency in which a given node is positioned along the shortest path between other nodes. This metric can identify the role that the node plays in connecting different parts of the network. The eigenvector centrality metric measures a relative metric value for a given node based on the metrics of connected nodes.

In various aspects, the centrality metric may be a component of the fraud metric algorithm and may be calculated as an inverse centrality value. In contrast to determining the centrality of a merchant node to a network, an inverse centrality metric highlights outlier merchant nodes that may have attenuated relationships to all other nodes in the network. This inverse metric de-emphasizes the impact of large merchants such as Amazon and Walmart and helps to identify fake merchants. For example, an inverse degree centrality metric may be calculated as: C_{DInv}(MNᵢ)=n/E_{Sum}(MNᵢ), where n is the total number of customer account nodes in the network and is the maximum number of degrees for any given merchant node, and E_{Sum}(MNᵢ) is the summation of all edge values of the edges connected to a merchant node “Nᵢ”. For example, the inverse degree centrality metric, C_{DInv}(MNᵢ), is calculated for merchant nodes 302c and 302e as C_{DInv}(node 302c)=9/8 while C_{DInv}(node 302e)=9/1. In this example, the inverse degree centrality metric indicates that merchant node 302e has a more attenuated relationship to the rest of the network 300 in comparison to merchant node 302c that has 8 edge connections. Therefore, node merchant 302e may have a higher likelihood of engaging in fraudulent activity, based on the inverse degree centrality.

The degree centrality metric may also be calculated for each edge representing one or more transactions between a merchant node, “MNᵢ”, and a customer node, “CNⱼ”, where the degree centrality metric is calculated as C_{DTotalT}(MNᵢ, CNⱼ)=E_{T}(MNᵢ, CNⱼ)/[E_{T}(MNᵢ, CNⱼ)+E_{T}(MNᵢ, CNⱼ₊₁) . . . + . . . E_{T}(MNᵢ, CNₖ)], and where k is the total number of customer account nodes that engage in transactions with merchant node MNᵢ. This degree centrality metric, C_{DTotalT}(MNᵢ, CNⱼ), measures the total number of transactions or total purchased amount for one or more transactions in a predetermined time period, E_{T}(MNᵢ, CNⱼ), as a ratio to the total number of transaction or total purchase amount for all customer nodes,

$${\sum }_{k}^{j} {E}_{T} ( {MN}_{i} , {CN}_{j} ) ,$$

that engage in transaction with the merchant node MNᵢ. In another example, the degree centrality metric, for each edge that engages the merchant node MNᵢ, may be calculated as C_{DAveT}(MNᵢ, CNⱼ)=E_{T}(MNᵢ, CNⱼ)/[(E_{T}(MNᵢ, CNⱼ)+E_{T}(MNᵢ, CNⱼ₊₁) . . . + . . . E_{T}(MNᵢ, CNₖ))/k], based on an average number of transactions or an average purchase amount in a predetermined time period,

$$\frac{{\sum }_{k}^{j} E T ( {MN}_{i} , {CN}_{j} )}{k} .$$

The fraud metric algorithm may include a weighted edge value that weights transactions for between a given customer node relative to similar customer nodes that engage with the merchant. The weighted edge values may be calculated for edges representing one or more transactions between the given customer account node, “CNⱼ”, and the corresponding merchant node, “MN”. The weighted edge value may be calculated as E_{W}(MNᵢ, CNⱼ)=C_{DInv}(MNᵢ)*C_{DTotalT}(MNᵢ, CNⱼ) for the total number of transactions or total transaction amount, or calculated as E_{W}(MNᵢ, CNⱼ)=C_{DInv}(MNᵢ)*C_{DAvelT}(MNᵢ, CNⱼ) based on the average number of transactions or average transaction amount. In certain implementations, community detection may use modularity optimization methods (e.g., Louvain algorithm) or spectral clustering techniques to partition the graph into clusters representing high intra-group density, which may be used to isolate suspected fraud rings.

The fraud metric algorithm may include a weighted value that compares the edges of a given node to a similar node in the network. For example, two or more account nodes may be considered similar if they share the same edge connections with one or more merchant nodes. Similar nodes may be grouped based on node type (customer account, merchant), amount of historical data (e.g., at least a predetermined number of data points), age of accounts (e.g., newly created accounts may be highly scrutinized based on incidences rate for fraudulent activity) purchase frequency, average or overall purchase amounts of predetermined periods, or other metrics including clustering coefficients.

The fraud metric algorithm may include a weighted value for a community affiliation metric that identifies sub-groups of nodes within the network. The community affiliation metric may be implemented using modularity-based clustering algorithms such as Louvain or label propagation to identify subgraphs with densely connected nodes, indicative of shared transaction behavior or merchant overlap. The fraud detection server 212 may determine community affiliation based on the frequency and/or purchase amount for transactions for specific merchant accounts. Network nodes may belong to one or more communities based on their edges and the fraud detection model that defines community affiliation. For example, customer account nodes 304a-c may be considered part of the same community based on common edges with merchant nodes 302a-b. Additionally, different communities may be weighted according to a likelihood that the nodes engage in fraudulent activity. If a customer belongs to multiple communities, the community affiliation metric may be weighted based on a proportional purchase amount in comparison to their overall purchase amounts for a predetermined period. For example, the fraud detection server 212 may determine, based on a fraud model, that transactions in a specific community are highly correlated to fraudulent activity, and a weighted value is assigned by the fraud model to account for this risk.

In various aspects, the system may include nodes in the network graph based on a minimum number of transactions, account age, or other information to establish a baseline for each node. In some embodiments, nodes may be excluded from the graph if they fall below a confidence threshold based on transaction count, account longevity, or transaction recency to mitigate skew from incomplete behavioral profiles. For example, newly created customer accounts may have little to no data to determine node similarity or community affiliation, which may decrease the accuracy of the fraud detection model. Additionally, newly created customer accounts with less than a predetermined number of transactions may have a higher incidences rate for fraudulent activity, in comparison to the overall incidence rate for network nodes. Therefore, all newly created accounts may be highly scrutinized for fraudulent activity until they reach a threshold level of activity for node similarity or community affiliation.

The fraud metric algorithms may comprise different weighting values, based on a fraud model, that correlate to different types of fraudulent activity between merchant nodes and customer account nodes. For example, the fraud model may be particularly helpful to identify coordinated fraudulent activity such as fraud rings, card skimming, and money laundering. Fraudulent actors may engage in coordinated fraudulent activity by controlling merchant accounts and customer accounts. They may use merchants and customers to work together to exploit protections provided by the financial institutions designed to shield legitimate customers from liability.

The fraudulent actors may coordinate fraudulent activity among a plurality of accounts by creating fake customer accounts (e.g., identity theft), accessing existing customer accounts through unauthorized access (e.g., data breach), deceiving legitimate users of customer accounts, or coordinating with multiple fraudulent actors in a ring that provides kickbacks to each member of the ring. The fraudulent actors may create fake customer accounts to make purchases for nonexistent goods/services and then dispute the charges claiming the purchase was made without their authorization or they never received the goods or services (which did not exist). Although financial institutions may initiate post-dispute investigations, fraudulent accounts are often abandoned shortly after use, limiting the ability to correlate the account activity with a verifiable identity. This typically occurs when a new account is created with stolen information (e.g., identity theft) or unauthorized access to an existing legitimate account. In another example, multiple fraudulent actors may receive “kickbacks” or a portion of the fraudulent gains in exchange for processing fake transactions and/or issuing refunds for non-existent returns. Traditional systems may have a difficult time identifying these transactions because they may intermingle legitimate transactions with fraudulent transactions.

The fraudulent actors may obtain customer information from card skimmers allowing fraudulent transaction to be intermingled with legitimate transactions. The fraud model may target customer accounts that include transactions with a specific merchant during a predetermined time period to prevent legitimate accounts from being used in a fraud ring. These accounts may be identified based on interactions with a legitimate merchant during a first time period and a fake merchant during a second time period.

Additionally, fraudulent actors may coordinate relationships to make a merchant appear as a legitimate merchant as a form of money laundering. The fraudulent actors may use the payment network to make illicit funds appear legitimate and/or circumvent bank reporting requirement for cash deposits.

Once the metric value is calculated, the fraud detection server 212 may determine that the node is associated with a type of fraud based on threshold. The fraud detection server 212 may execute one or more of a plurality of responses based the fraud metric and/or fraud model. The response may be tailored to a specific type of fraud that may be derived from one or more metric values calculated for a node. The fraud responses may include flagging an account, blacklisting the account, decreasing a credit limit for the account, generating a notification to a department or regulatory agency (e.g., external resource 216), or requesting tax documentation.

The financial institution may flag customer accounts and merchants associated with fraud, where the potentially fraudulent accounts may be frozen or monitored. In various embodiments, once the fraud detection server 212 determines that a node-such as a customer account node or merchant node—exceeds a fraud threshold based on the fraud metric algorithm and fraud detection model, the financial institution may initiate a flagging process to mark the associated account for enhanced scrutiny or restricted activity. The flagging process may be implemented by writing a fraud indicator or risk status value into one or more internal databases maintained by the financial institution. For example, in an embodiment where customer accounts and merchant profiles are stored in a centralized customer relationship management (CRM) system or core banking database, the fraud detection server 212 may transmit a flagging command via an internal API or secure messaging interface. The command may include the account identifier, merchant identifier, fraud type (e.g., suspected fraud ring, identity theft, or money laundering), the fraud metric value, timestamp of the flagging action, and any supporting evidence or context derived from the network graph. Upon receiving the command, the CRM system or account management system may write a corresponding status field (e.g., fraud_flag=TRUE, risk_level=HIGH, or flag_reason=SUSPICIOUS_PATTERN) to the appropriate record.

In one embodiment, the fraud detection server 212 may invoke a microservice or middleware layer within the financial institution's system architecture, which is configured to orchestrate downstream actions such as account flagging, workflow initiation for compliance review, and notification generation. The middleware may access the customer or merchant profile via an internal service bus and update the record atomically, ensuring consistency and auditability.

In another embodiment, the financial institution may maintain a dedicated fraud registry or watchlist database, which operates as a standalone or replicated repository of accounts flagged for fraud-related concerns. In this configuration, the fraud detection server 212 writes the account or merchant identifiers to the fraud registry, along with fraud metadata, severity levels, and expiration conditions (e.g., flags that expire after a fixed period unless renewed). Internal systems—such as authorization engines, risk management tools, and customer service interfaces—may query this registry in real time to determine whether an account is flagged before processing a transaction, approving a new service request, or issuing funds.

Flagging may trigger automated or semi-automated enforcement mechanisms, including but not limited to: requiring multi-factor authentication before allowing account access, temporarily disabling certain transaction types, denying authorization requests above a threshold amount, or escalating the account to a compliance or risk officer for manual review. These responses may be coordinated through rule engines or decision logic embedded in the financial institution's transaction processing infrastructure.

In secure environments, all flagging actions may be logged to an immutable audit trail or event log, capturing the actor (e.g., fraud detection server 212), timestamp, flagged account, flag type, and any subsequent actions taken (e.g., alert issued, account frozen, investigation opened). This log may be used for regulatory reporting, internal analytics, or incident response.

If an account is being monitored, the financial institution may deny authorization requests and/or require additional information from the customer ensuring the account is under the control of the user and is not compromised. In various embodiments, when the fraud detection server 212 determines that a customer account node exceeds a fraud threshold or otherwise exhibits anomalous behavior, the financial institution may place the account into a monitored status. While under monitoring, the financial institution may implement real-time authorization control measures designed to limit risk exposure and verify the authenticity of transaction requests. The denial of authorization requests may be implemented through integration with the financial institution's transaction authorization engine, which is typically responsible for validating and approving transaction requests received from issuer systems 108 during the authorization phase. The authorization engine may access account profile data stored in a centralized account management database or in a dedicated risk flagging service. When a transaction authorization request is received (e.g., via a payment network 106 or acquirer system 104), the authorization engine may query the monitored status of the associated account using the account identifier included in the request payload.

If the account is marked with a monitored or restricted status, the authorization engine may apply predefined decision rules or invoke a dynamic risk evaluation process. These decision rules may be encoded in a rules engine or policy management system that associates specific account flags with corresponding authorization actions. For example, if an account is flagged as “under review,” the rules engine may automatically return a denial code (e.g., ISO 8583 response code 05—Do Not Honor, or 62—Restricted Card) in response to any attempted authorization.

In certain embodiments, the authorization engine may escalate the transaction for step-up authentication, such as requiring the customer to complete an out-of-band verification via mobile app, one-time passcode (OTP), biometric confirmation, or a secure web portal. These authentication workflows may be coordinated by an authentication service or identity verification platform that interfaces with the customer's registered contact methods and device information.

The system may also include logic to track attempted transactions from monitored accounts and log denial events for auditing, review, and adaptive risk scoring. For example, if multiple denied transactions are observed within a short period, the system may increase the risk score associated with the account or escalate the case to a human fraud analyst. To maintain performance, authorization denials and additional authentication requests may be processed within milliseconds, enabling real-time fraud prevention without disrupting overall system throughput. The architecture may include caching layers, rate-limiting mechanisms, and parallel decision pathways to support high transaction volumes while enforcing fraud policies for monitored accounts.

The financial institution may blacklist identified fraudulent accounts from engaging with their customer accounts, creating accounts with their financial institutions, or may work with payment network service providers to blacklist all account activity associated with the identified fraudulent accounts. Payment network service provider may have reciprocal relationships with other payment networks such that the identified fraudulent accounts (e.g., merchant or customer account nodes) are blacklisted from as many payment networks as possible. Additionally, specific account information may be flagged to help prevent the fraudulent actor from creating a new fake merchant with similar information. In various embodiments, once the fraud detection server 212 determines that a customer account or merchant account has exceeded a fraud threshold, the financial institution may initiate a blacklisting process. This process is implemented by updating internal and external systems to prevent further activity from the identified fraudulent account and to inhibit future attempts to create new accounts using the same or similar information.

From a technical perspective, the blacklisting operation may begin with the fraud detection server 212 transmitting a blacklist instruction to the institution's internal account control system or risk management platform. This instruction includes identifying information such as the account number, customer or merchant ID, payment token, associated email addresses, device identifiers, IP addresses, business name, tax ID, or any other metadata that may be used to associate a transaction or entity with known fraudulent behavior.

The internal systems may respond by writing one or more blacklist entries to a secure, access-controlled blacklist database or registry. This database may support fast lookups by key identifiers and may be queried in real-time by other systems, such as the transaction authorization engine, account onboarding system, and customer service interface. When a transaction authorization request is received that includes a blacklisted account or linked identifier, the authorization engine may immediately deny the transaction based on a policy lookup from the blacklist. Similarly, if a new account registration attempt is detected that includes blacklisted attributes—such as a flagged device fingerprint, IP address, or email domain—the registration process may be blocked or escalated for manual review.

In some embodiments, the blacklist database may include hash values of sensitive data (e.g., hashed PANs, email addresses, or SSNs) to preserve data security and comply with data protection regulations, while still enabling detection of known patterns. Pattern-matching algorithms or machine learning models may also be employed to detect variants or similar patterns to those in the blacklist (e.g., business names using minor spelling variations or transposed characters).

To enforce blacklisting across broader network boundaries, the financial institution may transmit blacklisting records to one or more affiliated payment network service providers 106. These communications may be implemented using secure APIs, message queues, or encrypted file transfers (e.g., SFTP), and may conform to established industry protocols for fraud and risk data exchange. The transmitted data may include standardized fraud codes, account identifiers, merchant descriptors, and reason codes in accordance with network-specific requirements (e.g., Mastercard MATCH, Visa VMPI, or shared fraud databases under consortium arrangements).

Upon receipt, the payment network provider may ingest the data into its own internal blacklisting system and propagate blacklist records to other participating acquirers, issuers, and network operators. This may be done through established reciprocal agreements, such that fraud alerts and blacklisting data shared by one institution are made available to others within the network. In some cases, the network may maintain a centralized fraud registry that is queried in real time during transaction processing to prevent activity from accounts previously identified as fraudulent by other institutions.

To further suppress fraudulent actors from re-entering the system under a different identity, the financial institution may generate and store risk profiles or signatures derived from previously blacklisted accounts. These signatures may include behavioral patterns, network characteristics (e.g., link patterns in transaction graphs), or synthetic identifiers generated by identity resolution systems. During onboarding or transaction activity, new entities may be compared against these risk signatures, and if a strong correlation is found, the system may flag or block the activity as an attempted evasion of the blacklist.

In addition to the network graph and the fraud metric algorithm, the financial institutional may request or receive additional information for specific accounts to further confirm or rule out fraudulent activity. For example, if the node exceeds a predetermined threshold, the financial institution may review recent transactions in comparison to historical transactions, patterns for fraudulent merchant-customer account interactions, or similar nodes in affiliated communities. In response to the additional evaluations, the financial institution may freeze the account pending a review (e.g., likely unauthorized access or identity theft) or monitor the account (e.g., likely legitimate but unusual activity). The financial institution may also set lower credit transaction or daily credit limits for identified accounts to limit or decrease their risk exposure for potentially fraudulent transactions.

For example, the financial institution may initiate a secondary evaluation process to confirm or rule out fraudulent activity. This process involves programmatically collecting and analyzing supplementary data associated with the identified account to assess the nature and risk level of the observed behavior. Upon exceeding the fraud threshold, the fraud detection server 212 may trigger an internal alert and transmit a case package to a fraud investigation engine or case management system. The case package may include the account identifier, the fraud metric value, a timestamp of detection, the calculated components of the fraud metric (e.g., inverse centrality, community affiliation, node similarity), recent transaction details, and a historical behavioral profile of the account. This data may be retrieved from the transaction database 214, the network graph data store, and/or user profile databases. The financial institution may execute an automated or semi-automated review process. In one embodiment, a transaction comparison module may query the transaction database 214 to retrieve recent transaction activity (e.g., transactions within the past 7 days) and compare it to historical behavior patterns (e.g., over the prior 6-12 months). Attributes such as transaction frequency, merchant categories, geographic locations, device fingerprints, purchase amounts, and payment instruments may be evaluated for deviations. For example, if the account historically transacted with regional grocery and retail stores but suddenly initiates international, high-value transactions with obscure online merchants, the system may assign an elevated anomaly score.

Additionally, the system may perform a graph-based analysis of behavioral similarity across nodes. For example, the fraud detection server 212 may query the network graph to identify other customer account nodes within the same community affiliation or possessing high similarity scores. If the flagged node exhibits patterns consistent with nodes previously confirmed as fraudulent, the system may weigh this evidence in support of freezing or restricting the account. Based on the results of this supplementary evaluation, a risk decision engine may execute one or more enforcement actions. If the analysis indicates a high probability of unauthorized access or identity theft, the system may initiate a full account freeze by transmitting a freeze instruction to the account control subsystem via an account control API, where the account control API may interface with a banking core or card issuance platform to disable settlement, reverse pending transactions, and prevent further disbursements. This action may immediately disable transaction authorizations, restrict login attempts, and flag the account for manual investigation by fraud analysts.

If the behavior is deemed unusual but not conclusively fraudulent—such as unexpected purchases from a legitimate new merchant—the system may instead place the account under active monitoring. In this state, the account may remain usable, but real-time transaction authorization may be augmented with additional checks (e.g., device fingerprint validation, location matching, or behavioral authentication). Monitoring status may be reflected in account metadata, and monitored accounts may be prioritized for periodic review or alerts on suspicious activity. To mitigate risk exposure during this period, the financial institution may also dynamically adjust spending limits. For example, a credit limit management module may receive an instruction to temporarily reduce the account's daily or per-transaction limit based on a predefined policy or risk tier. These updated limits may be written to the account management system and enforced by the transaction authorization engine at runtime.

All actions taken—such as the outcome of the supplementary review, account freeze, monitoring flag, or limit adjustment—may be logged in an audit database for compliance, internal reporting, and further model training. These outcomes may also be fed back into the fraud detection model as part of supervised learning workflows to improve future fraud classification accuracy.

In other situations, the financial institution may generate notifications or alerts to other departments (e.g., Anti-money laundering division) within the financial institution or regulatory agencies as part of a required reporting requirement. For example, a fraudulent actor may create a series of coordinated transactions to circumvent a bank reporting requirement for cash deposits in excess of a predetermined amount. The financial institution can alert department of treasury, IRS, or other regulatory agencies that police tax evasion or money laundering. For example, when the fraud detection server 212 determines that a customer account, merchant account, or series of transactions indicates behavior consistent with a regulatory violation—such as structuring, money laundering, or tax evasion—the financial institution may initiate a reporting process to notify internal departments (e.g., Anti-Money Laundering (AML) division, Compliance Office) and external regulatory agencies, such as the Department of the Treasury, Financial Crimes Enforcement Network (FinCEN), or the Internal Revenue Service (IRS). This process may be implemented by the fraud detection server 212 or an affiliated compliance automation module that monitors transaction patterns and evaluates fraud metric data in conjunction with statutory thresholds and regulatory rules. When the fraud metric value, transaction characteristics, or pattern of account behavior match a predefined rule (e.g., multiple cash deposits just below the reportable limit over a short time window), the fraud detection system may generate a report event payload. This payload may include: the account identifier(s), merchant identifier(s), transaction timestamps and amounts, calculated fraud metric values, pattern-matching results (e.g., flagged as potential structuring or layering activity), and relevant context from the network graph analysis.

The fraud detection server 212 may write this report event to a centralized case management or alerting system used by the financial institution's AML or compliance department. This system may be implemented using enterprise compliance platforms (e.g., Actimize, SAS AML, or proprietary solutions) that support internal workflows for suspicious activity report (SAR) preparation and escalation. The alert may be prioritized and routed to analysts based on severity, type of suspected activity, or the regulatory framework involved (e.g., Bank Secrecy Act (BSA) thresholds, AMLA reporting requirements, or IRS cash transaction reporting rules).

For internal routing, the fraud detection server 212 may interact with a notification engine or publish the alert to a message queue or service bus (e.g., Apache Kafka, Amazon SNS/SQS) configured to deliver real-time event notifications to the appropriate business units. Notification formats may include structured JSON, XML, or custom schemas compliant with the institution's internal messaging protocols.

In situations where automatic regulatory reporting is authorized or required, the system may prepare and submit formal reports directly to external agencies. For example, if the suspicious activity meets the criteria for a SAR filing, the system may populate a SAR form template with relevant account and transaction data and transmit it electronically via a secure regulatory interface, such as FinCEN's BSA E-Filing System. File formats and schemas may comply with applicable standards, such as FinCEN XML schema definitions or IRS Form 8300 reporting guidelines. The transmission of such reports may involve cryptographic signing, secure file transfer protocols (e.g., SFTP, HTTPS with mutual TLS), and audit logging to ensure traceability, authenticity, and compliance with institutional and regulatory data security policies. Submission acknowledgments or receipt confirmations may be parsed by the system and logged to a compliance record database. To detect circumvention behavior such as structuring—where a fraudulent actor spreads a series of transactions just below a statutory reporting threshold—the system may use time-series analysis and rule-based detection logic. For example, a transaction monitoring module may aggregate transactions over rolling time windows (e.g., daily, weekly) and evaluate cumulative values against known thresholds (e.g., cash deposits exceeding $10,000 within 24 hours). Suspicious patterns may be further validated using graph-based analysis to detect common ownership, device usage, or community affiliation among multiple accounts involved in the behavior.

The financial institution may request tax documentation from a suspected fraudulent merchant to verify the merchant's legitimacy and substantiate the accuracy of the reported transactions. If the account holder fails to comply within a predetermined time period, the financial institution may take further action including freezing the account or escalating the inquiry with other departments, financial institutions, or regulatory agencies. For example, when the fraud detection server 212 identifies a merchant node that exceeds a fraud threshold or exhibits suspicious transactional patterns, the financial institution may initiate a tax information verification process. This process is designed to confirm the legitimacy of the merchant and validate the accuracy and provenance of the associated transactions. Upon detection of suspicious activity, the fraud detection server 212 may transmit a structured case object to a compliance workflow engine or document management system responsible for merchant due diligence. The case object may include the merchant identifier, the fraud metric value, relevant transaction history, graph-based metrics (e.g., community affiliation and inverse centrality), and a classification of the suspected fraud type (e.g., synthetic merchant creation, unreported income, or transaction laundering).

The workflow engine may automatically generate a tax documentation request based on predefined policies. This request may include a request for federal tax identification documentation (e.g., IRS Form W-9, EIN verification), business license records, proof of incorporation, or past tax filings. The request may be generated as a digital communication sent via secure channels such as encrypted email, secure customer portals, or SMS-based links to authenticated upload interfaces. The system may use a document request module that generates a unique case ID, applies a submission deadline, and tracks the status of the merchant's response.

In one embodiment, the financial institution may leverage a secure document intake system, accessible through a web portal or mobile application, where the merchant can upload scanned or digitally signed tax documents. The system may apply file validation (e.g., file format checks, malware scanning, or electronic signature verification) and associate the uploaded documents with the original request record. The uploaded content may be stored in a secure document repository with role-based access controls and audit logging to ensure regulatory compliance.

To facilitate automated review, an intelligent document processing (IDP) system may extract key fields (e.g., EIN, business name, tax year) from the uploaded documents using OCR (optical character recognition) or machine learning-based entity recognition. These extracted values may be cross-referenced against internal records (e.g., merchant onboarding data) and external databases (e.g., IRS TIN matching services or commercial business verification services) to assess authenticity and consistency. If the merchant fails to respond within a predetermined timeframe (e.g., 10 business days), a deadline enforcement module may trigger escalation actions. These actions may include: (i) Automatically updating the merchant's account status to “Restricted” or “Under Review”; (ii) Freezing the merchant account by invoking the account control API to prevent new transactions from being initiated or settled; (iii) Generating an internal alert or escalation ticket routed to the financial institution's risk, fraud, or compliance team; and/or (iv) Logging the noncompliance event to an audit trail and updating the merchant's risk profile.

In certain implementations, if the merchant remains unresponsive or the submitted tax information is determined to be falsified or unverifiable, the system may escalate the matter to external entities. The escalation process may involve: (i) Transmitting the case to partner financial institutions via established interbank communication protocols (e.g., SWIFT messages, secure FTP exchanges); (ii) Notifying payment network service providers 106 of the suspected fraudulent merchant activity; and/or (iii) Preparing a report for submission to tax authorities or regulatory agencies such as the IRS, FinCEN, or the Department of the Treasury, depending on the jurisdiction and nature of the fraud.

All requests, responses, deadlines, status changes, and escalations may be logged in a centralized compliance case management system to ensure traceability, enable audit reviews, and support long-term enforcement actions.

The fraud detection model may determine a threshold value for specific types of fraud based on community affiliation and node similarity. Additionally, the fraud detection model may designate specific fraud responses based on an identified type of fraud and the metric value for the node.

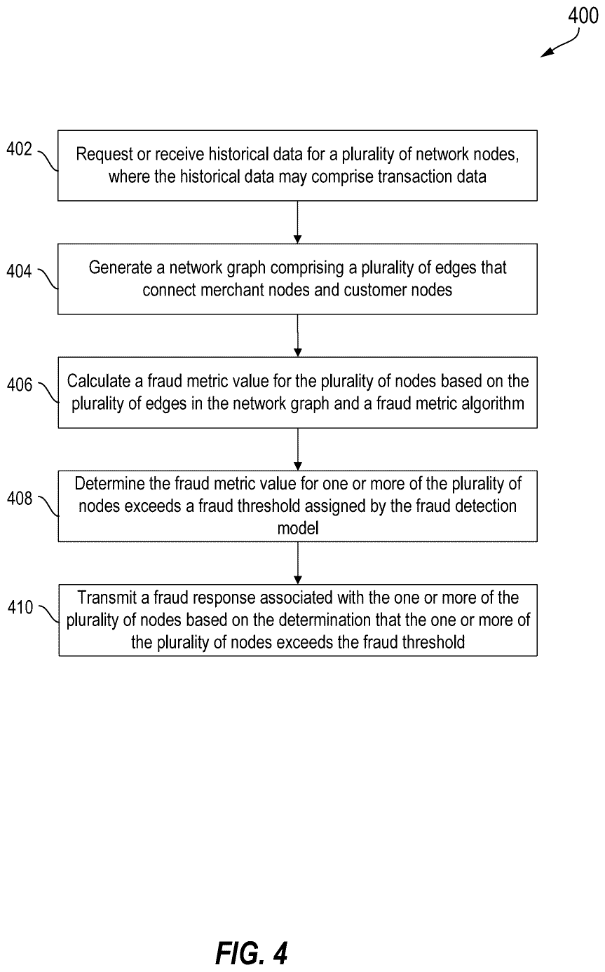

FIG. 4 shows a logic flow diagram 400 for detecting fraudulent activity based on a network graph for a plurality of nodes, according to various aspects of the present invention. A fraud detection server 212 requests or receives, at step 402, historical data for a plurality of network nodes, where the historical data may comprise transaction data. The fraud detection server 212 generates, at step 404, a network graph for the plurality of nodes. The network graph comprises a plurality of edges that connect merchant nodes and customer account nodes, based on one or more transactions, purchase amounts, or a weighted value based on transactions and/or purchase amounts. The fraud detection server 212 may require a predetermined number of transactions before nodes are included in the generated network graph. Additionally, the fraud detection server 212 may exclude merchant nodes based on a predetermined number of transactions and/or overall purchase amount. Additionally, the fraud detection server 212, at step 406, determines or calculates a fraud metric value for the plurality of nodes based on the plurality of edges in the network graph and a fraud metric algorithm. The fraud metric value may be comprised of a plurality of weighted metric values or weightings based on centrality, node similarity, and community affiliation. The fraud metric value may be calculated based on weightings determined by a fraud detection model. The fraud detection server 212, at step 408, determines the fraud metric value for one or more of the plurality of nodes exceeds a fraud threshold assigned by the fraud detection model. The fraud detection server 212, at step 410, transmits a fraud response associated with the one or more of the plurality of nodes based on the determination that the one or more of the plurality of nodes exceeds the fraud threshold, wherein the fraud response is associated with a specific type of fraud and the fraud detection model.

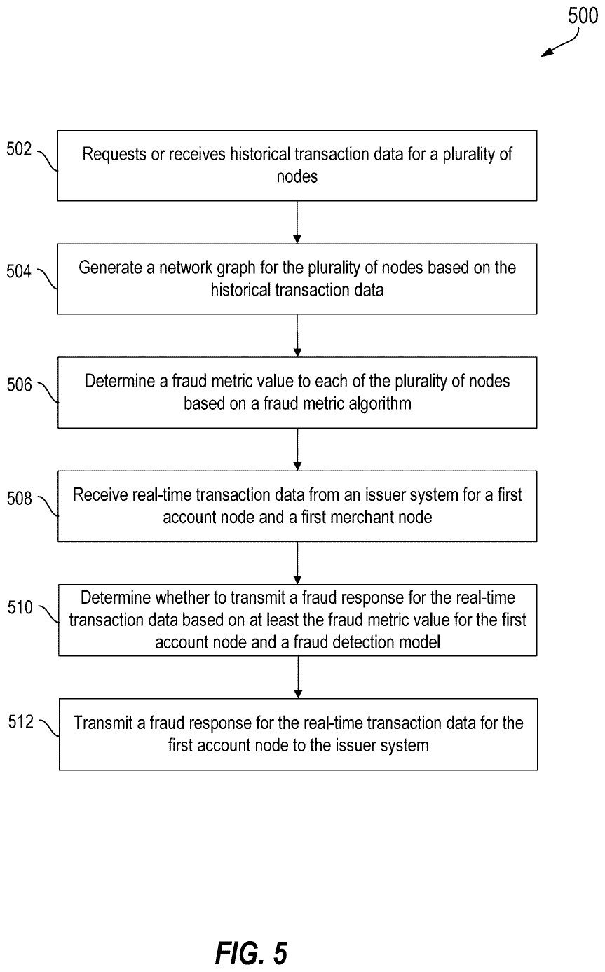

FIG. 5 shows a logic flow diagram 500 for detecting fraudulent activity based on a network graph for a plurality of nodes, according to various aspects of the present invention. A fraud detection server 212 requests or receives, at step 502, historical transaction data for a plurality of nodes. The fraud detection server 212 generates, at step 504, a network graph for the plurality of nodes based on the historical transaction data, where the plurality of nodes includes merchant nodes and customer account nodes. The network graph is generated by connecting the merchant nodes and the customer account nodes through a plurality of edges. The plurality of edges may represent a single transaction, or a weighed value based on a plurality of transaction, the purchase amounts for the plurality of transactions, or a weighted combination of transactions and purchase amounts in a predetermined period. The fraud detection server 212 determines, at step 506, a fraud metric value to each of the plurality of nodes based on a fraud metric algorithm. The fraud detection server 212 receives, at step 508, real-time transaction data from an issuer system for a first customer account node and a first merchant node. The fraud detection server 212 determines, at step 510, whether to transmit a fraud response for the real-time transaction data based on at least the fraud metric value for the first customer account node and a fraud detection model. The fraud detection server 212 may receive the fraud detection model as a pretrained model by an external source 218 or may receive fraud detection data from an external source 218 allowing the fraud detection server 212 to train and generate the fraud detection model. The fraud detection server 212 may determine that a fraud response is warranted based on the fraud metric value, fraud detection model, real-time transaction data, and a threshold value. The fraud detection server 212 transmits, at step 512, a fraud response for the real-time transaction data for the first customer account node to the issuer system. The fraud response may include transmitting a response to the issuer system to deny the transaction and/or freeze the accounts associated with a financial institution.

Examples of the method according to various aspects of the present disclosure are provided below in the following numbered clauses. An aspect of the method may include any one or more than one, and any combination of, the numbered clauses described below.

In one general aspects, therefore, the present invention is directed to fraud detection method and system, including a method to generate and detect fraudulent activity in a payment network. The method includes a first step of receiving transaction data for a plurality of nodes at a server system. In a next step, the server system generates a network graph for the plurality of nodes based on the transaction data, wherein the plurality of nodes comprises merchant nodes and customer account nodes, and wherein the network graph connects the merchant nodes and the customer account nodes through a plurality of edges. The method continues with the server system determining a fraud metric value for the plurality of nodes based on a fraud metric algorithm and the network graph, and determining the fraud metric value for one or more of the plurality of nodes exceeds a fraud threshold, wherein the fraud threshold is based on a fraud detection model, wherein the fraud detection model is trained using historical transaction data to assign thresholds associated with specific fraud types. Based on the determined fraud metric value for the one or more of the plurality of nodes exceeds the fraud threshold, and the server system transmits a fraud response associated with the one or more of the plurality of nodes based on the determining that the fraud metric value for the one or more of the plurality of nodes exceeds the fraud threshold.

In various implementations of the method, the transaction data includes at least one of transaction timestamps, customer account identifiers, merchant identifiers, transaction amounts, authorization codes, or a combination.

In various implementations, the method continues by periodically updating the network graph based on newly received transaction data, wherein the updating includes recalculating, by the server system, edge weights and fraud metric values for one or more nodes, and wherein the fraud threshold is dynamically adjusted based on temporal fraud trends.

In various implementations of the method, the fraud metric value comprises a weighted combination of an inverse degree centrality metric, a modularity-based community detection score, and a transaction behavior similarity score between account nodes.

In various implementations, the method generates the network graph by determining the customer account nodes are associated with a minimum number of transactions in a predetermined period, and determining a weighted edge value for each of the plurality of edges. The weighted edge value is determined based on an inverse centrality metric for a merchant node multiplied by an edge value for the number of transactions between the merchant node and a customer account node, a purchase amount between the merchant node and the customer account node, or a combination thereof.

In various implementations of the method, the fraud metric algorithm includes at least one graph-based metric, specifically including a merchant centrality metric, a community affiliation metric, a node similarity metric, or a combination thereof. The merchant centrality metric is determined with an inverse degree centrality metric, wherein the inverse degree centrality metric is based on a ratio of total node count to the number of edges connected to a merchant node.

In various implementations, the method continues by determining the fraud response as one or more of: flagging one or more accounts associated with the one or more of the plurality of nodes, blacklisting the one or more accounts associated with the one or more of the plurality of nodes, decreasing a credit limit for the one or more accounts associated with the one or more of the plurality of nodes, generating a structured alert to a regulatory agency based on a determination that a fraud type corresponds to a regulatory reporting obligation, generating a request for tax information for the one or more accounts associated with the one or more of the plurality of nodes, or a combination thereof. Additionally, the fraud response includes transmitting a freeze command to a core banking system via an account control API, wherein the freeze command disables outgoing transactions and authentication attempts for the flagged account.

In various implementations, the method continues by determining a community affiliation metric and a node similarity metric for each of the customer account nodes, wherein the fraud threshold is determined based on the community affiliation metric. Additionally, the server system is determining a fraud type associated with the one or more of the plurality of nodes exceeding the fraud threshold, wherein the fraud type is based on the fraud detection model and one or more of: the community affiliation metric, the node similarity metric, the fraud metric value, or a combination thereof for the one or more of the plurality of nodes. The method continues by determining the fraud response based on the fraud type associated with the one or more of the plurality of nodes, wherein the fraud type comprises fraud rings, money laundering, and identity theft, and/or correlating the fraud detection model and the fraud threshold to the community affiliation metric and the node similarity metric for each of the plurality of nodes.

In another general aspect, the method can also be configured for receiving historical transaction data for a plurality of nodes server system. The method continues by generating a network graph for the plurality of nodes based on the historical transaction data, wherein the plurality of nodes comprises merchant nodes and customer account nodes, and wherein the network graph connects the merchant nodes and the customer account nodes through a plurality of edges. The method is determining a fraud metric value to each of the plurality of nodes based on a fraud metric algorithm and receiving real-time transaction data from an issuer system for a first customer account node of the customer account nodes and a first merchant node. The method continues by determining a fraud response for the real-time transaction data based on at least the fraud metric value for the first customer account node and a fraud detection model, wherein the fraud response is determined based on a comparison between the fraud metric value for the first customer account node and a dynamically updated fraud threshold based on the fraud detection model. Once the server system determines a fraud response, the method continues by transmitting the fraud response for the real-time transaction data for the first customer account node to the issuer system.

In various implementations, the method continues by determining the first merchant node is one of the merchant nodes present in the network graph, and determining, by the server system, a community affiliation associated with the first merchant node, based on the fraud detection model, wherein the fraud response is based on the community affiliation associated with the first merchant node.

In various implementations of the method the fraud response includes at least one of declining an authorization associated with the real-time transaction data for the first customer account node, freezing one or more accounts associated with the first customer account node or the first merchant node, or a combination thereof.

In various implementations, the method continues by receiving the fraud detection model from an external source, wherein the fraud detection model is updated based on a predetermined interval for fraud detection data.

In various implementations, the method continues by receiving fraud detection data from an external source, wherein the fraud detection data is updated based on a predetermined interval, and training the fraud detection model using supervised learning based on labeled fraud detection data.

In another general aspect of the present invention, the fraud detection system includes a payment network, a transaction database, and a fraud detection server. The payment network includes a payment processing server configured to facilitate transactions between a plurality of issuer systems and a plurality of acquirer systems. The transaction database in communication with the payment network, wherein the transaction database is configured to store transaction data associated with the transactions in the payment network. The fraud detection server is configured to communication with the transaction database and configured to receive the transaction data via a secure interface. Additionally, the fraud detection server is configured to perform various operations. The fraud detection server generates a network graph for a plurality of nodes based on the transaction data, wherein the plurality of nodes comprises merchant nodes and customer account nodes, and wherein the network graph connects the merchant nodes and the customer account nodes through a plurality of edges. The fraud detection server determines a fraud metric value for each of the plurality of nodes based on a fraud metric algorithm. The fraud detection server determines the fraud metric value for a first customer account node of the plurality of nodes exceeds a fraud threshold, wherein the fraud threshold is based on a fraud detection model, and the fraud detection server transmits a fraud response associated with the first customer account node based on the determination that the first customer account node exceeds the fraud threshold.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. Persons skilled in the art will appreciate that recited operations therein may generally be performed in any order. Also, although various operational flow diagrams are presented in a sequence(s), it should be understood that the various operations may be performed in other orders than those which are illustrated, or may be performed concurrently. The disclosed embodiments are therefore intended to include all such modifications, alterations, and adaptations without departing from the scope of the embodiments as set forth herein.

What is claimed is:

1. A method comprising:
receiving, by a server system, transaction data for a plurality of nodes;
generating, by the server system, a network graph for the plurality of nodes based on the transaction data, wherein the plurality of nodes comprises merchant nodes and customer account nodes, and wherein the network graph connects the merchant nodes and the customer account nodes through a plurality of edges;
determining, by the server system, a fraud metric value for the plurality of nodes based on a fraud metric algorithm and the network graph;
determining, by the server system, the fraud metric value for one or more of the plurality of nodes exceeds a fraud threshold, wherein the fraud threshold is based on a fraud detection model, wherein the fraud detection model is trained using historical transaction data to assign thresholds associated with specific fraud types; and
transmitting, by the server system, a fraud response associated with the one or more of the plurality of nodes based on the determining that the fraud metric value for the one or more of the plurality of nodes exceeds the fraud threshold.

2. The method of claim 1, wherein the transaction data comprises at least one of: transaction timestamps, customer account identifiers, merchant identifiers, transaction amounts, authorization codes, or a combination.

3. The method of claim 1, further comprising:
periodically updating, by the server system, the network graph based on newly received transaction data, wherein the updating includes recalculating, by the server system, edge weights and fraud metric values for one or more nodes, and wherein the fraud threshold is dynamically adjusted based on temporal fraud trends.

4. The method of claim 1, wherein the fraud metric value comprises a weighted combination of an inverse degree centrality metric, a modularity-based community detection score, and a transaction behavior similarity score between account nodes.

5. The method of claim 1, wherein the generating, by the server system, the network graph is further comprising:
determining, by the server system, the customer account nodes are associated with a minimum number of transactions in a predetermined period; and
determining, by the server system, a weighted edge value for each of the plurality of edges.

6. The method of claim 5, wherein the weighted edge value is based on an inverse centrality metric for a merchant node multiplied by an edge value for the number of transactions between the merchant node and a customer account node, a purchase amount between the merchant node and the customer account node, or a combination thereof.

7. The method of claim 1, wherein the fraud metric algorithm comprises at least one graph-based metric, including: a merchant centrality metric, a community affiliation metric, a node similarity metric, or a combination thereof.

8. The method of claim 7, wherein the merchant centrality metric is an inverse degree centrality metric, wherein the inverse degree centrality metric is based on a ratio of total node count to the number of edges connected to a merchant node.

9. The method of claim 1, wherein the fraud response comprises one or more of:
flagging, by the server system, one or more accounts associated with the one or more of the plurality of nodes;
blacklisting, by the server system, the one or more accounts associated with the one or more of the plurality of nodes;
decreasing, by the server system, a credit limit for the one or more accounts associated with the one or more of the plurality of nodes;
generating, by the server system, a structured alert to a regulatory agency based on a determination that a fraud type corresponds to a regulatory reporting obligation;
generating, by the server system, a request for tax information for the one or more accounts associated with the one or more of the plurality of nodes; or
a combination thereof.

10. The method of claim 9, wherein the fraud response comprises transmitting a freeze command to a core banking system via an account control API, wherein the freeze command disables outgoing transactions and authentication attempts for the flagged account.

11. The method of claim 1, further comprising: determining, by the server system, a community affiliation metric and a node similarity metric for each of the customer account nodes, wherein the fraud threshold is determined based on the community affiliation metric.

12. The method of claim 11, further comprising: determining, by the server system, a fraud type associated with the one or more of the plurality of nodes exceeding the fraud threshold, wherein the fraud type is based on the fraud detection model and one or more of: the community affiliation metric, the node similarity metric, the fraud metric value, or a combination thereof for the one or more of the plurality of nodes.

13. The method of claim 12, further comprising: determining, by the server system, the fraud response based on the fraud type associated with the one or more of the plurality of nodes, wherein the fraud type comprises fraud rings, money laundering, and identity theft.

14. The method of claim 12, further comprising: correlating, by the server system, the fraud detection model and the fraud threshold to the community affiliation metric and the node similarity metric for each of the plurality of nodes.

15. A method comprising:
receiving, by a server system, historical transaction data for a plurality of nodes;
generating, by the server system, a network graph for the plurality of nodes based on the historical transaction data, wherein the plurality of nodes comprises merchant nodes and customer account nodes, and wherein the network graph connects the merchant nodes and the customer account nodes through a plurality of edges;
determining, by the server system, a fraud metric value to each of the plurality of nodes based on a fraud metric algorithm;
receiving, by the server system, real-time transaction data from an issuer system for a first customer account node of the customer account nodes and a first merchant node;
determining, by the server system, a fraud response for the real-time transaction data based on at least the fraud metric value for the first customer account node and a fraud detection model, wherein the fraud response is determined based on a comparison between the fraud metric value for the first customer account node and a dynamically updated fraud threshold based on the fraud detection model; and
transmitting, by the server system, the fraud response for the real-time transaction data for the first customer account node to the issuer system.

16. The method of claim 15, further comprising:
determining, by the server system, the first merchant node is one of the merchant nodes present in the network graph; and
determining, by the server system, a community affiliation associated with the first merchant node, based on the fraud detection model, wherein the fraud response is based on the community affiliation associated with the first merchant node.

17. The method of claim 15, wherein the fraud response comprises at least one of:
declining, by the server system, an authorization associated with the real-time transaction data for the first customer account node;
freezing, by the server system, one or more accounts associated with the first customer account node or the first merchant node; or a combination thereof.

18. The method of claim 15, further comprising: receiving, by the server system, the fraud detection model from an external source, wherein the fraud detection model is updated based on a predetermined interval for fraud detection data.

19. The method of claim 15, further comprising:
receiving, by the server system, fraud detection data from an external source, wherein the fraud detection data is updated based on a predetermined interval; and
training, by the server system, the fraud detection model using supervised learning based on labeled fraud detection data.

20. A system comprising:
a payment network comprising a payment processing server configured to facilitate transactions between a plurality of issuer systems and a plurality of acquirer systems;
a transaction database in communication with the payment network, wherein the transaction database is configured to store transaction data associated with the transactions in the payment network;
a fraud detection server communicatively coupled to the transaction database and configured to receive the transaction data via a secure interface, and wherein the fraud detection server is configured to:
generate a network graph for a plurality of nodes based on the transaction data, wherein the plurality of nodes comprises merchant nodes and customer account nodes, and wherein the network graph connects the merchant nodes and the customer account nodes through a plurality of edges;
determine a fraud metric value for each of the plurality of nodes based on a fraud metric algorithm;
determine the fraud metric value for a first customer account node of the plurality of nodes exceeds a fraud threshold, wherein the fraud threshold is based on a fraud detection model; and
transmit a fraud response associated with the first customer account node based on the determination that the first customer account node exceeds the fraud threshold.
